(19) United States
(12) Patent Application Publication
(10) Pub. No.: US 2007/0060394 A1
(43) Pub. Date: Mar. 15, 2007

(54) Downloading upon the occurrence of predetermined events

(75) Inventors: Scott T. Gowin, Reno, NV (US); Rex Yinzok Lam, Reno, NV (US); Robert Leland Pickering, Reno, NV (US); Nadeem Ahmad Quraishi, Reno, NV (US); Steven G. LeMay, Reno, NV (US)

Correspondence Address: BEYER WEAVER LLP, P.O. BOX 70250, OAKLAND, CA, 94612-0250, US

(73) Assignee: IGT

(21) Appl. No.: 11/599,241

(22) Filed: Nov. 13, 2006

Related U.S. Application Data
(63) Continuation-in-part of application No. 11/269,940, filed on Nov. 8, 2005.
Application No. 11/269,940 is a continuation of application No. 09/823,833, filed on Mar. 30, 2001, now Pat. No. 6,979,266.

(51) Int. Cl. G06F 19/00

(52) U.S. Cl. 463/47

(57) ABSTRACT

Some aspects of the present invention provide for the downloading of code, including but not limited to peripheral device code, upon the occurrence of predetermined events, sometimes referred to herein as “triggers.” For example, exceeding a predetermined number of errors within a predetermined time may comprise a trigger. Some implementations provide new peripheral device code each time a gaming machine initializes. Some embodiments provide peripheral devices with relatively small (or no) non-volatile memory. A smaller non-volatile memory (as compared to prior art peripheral devices of the same type) may be possible because it is not necessary—and may not be desirable—to retain peripheral device code in non-volatile memory.

### RELATED APPLICATION DATA

The present application is a continuation-in-part of U.S. patent application Ser. No. 11/269,940, filed on Nov. 8, 2005 and entitled “GAMING MACHINES AND SYSTEMS HAVING PERIPHERAL CODE DOWNLOADING CAPABILITIES,” which is a continuation of U.S. patent application Ser. No. 09/823,833, filed on Mar. 30, 2001 and entitled “METHOD AND APPARATUS FOR DOWNLOADING PERIPHERAL CODE,” which issued as U.S. Pat. No. 6,979,266, both of which are hereby incorporated by reference.

### FIELD OF THE INVENTION

The present invention relates to methods and devices for providing software to peripheral devices of electronic gaming machines.

### BACKGROUND OF THE INVENTION

In computing environments it is common to associate one or more peripheral devices with a central controller or processor. As one example, electronic gaming machines may include a plurality of peripheral devices, such as a bill validator, a coin acceptor, a ticket dispenser, a video display, and a variety of other devices. These peripheral devices are associated with, and controlled partly by, one or more gaming control units.

Generally, each peripheral also has its own internal controller. This controller may comprise a processor arranged to execute control code, or hardware embodying the control code. The code, whether in the form of executable software or embodied in hardware, controls certain aspects of the operation of the peripheral device. In the example of a gaming machine, the gaming control unit may accept signals from and transmit signals to a bill validator peripheral. The transmitted signals may include control signals such as a signal instructing the bill validator to shut off or cease operation in the event the gaming device security is compromised. The bill validator may include specific code governing the bill validation process, such as code arranged to compare scanned bill image data to a particular set of fixed bill validation data.

In many instances, it is desirable to replace or modify the executable code associated with a peripheral. In those situations where the code is embodied in hardware, this requires that the peripheral be accessed and the hardware entirely replaced. This is both expensive and very time consuming. In the case of a gaming machine, when the machine is out of service for a peripheral code update, significant loss of revenues may occur. In the case where the code is stored in a memory device, such as read only memory (ROM), a new memory module may be installed. Again, this still requires access to the gaming machine.

Finding a potential solution to permit a change in the code associated with a peripheral is difficult when considering the many varied problems. If the peripheral code is to be updated or replaced, it is desirable to do so in a manner that ensures that the peripheral remains operational. For example, in the event the code is to be over-written to a flash memory, if a power interrupt occurs during the write process, the old code may be sufficiently overwritten, and the new code insufficiently instantiated, to permit the peripheral controller to operate. The entire memory module and/or controller of the peripheral must then be replaced. When considering gaming machines, security is of utmost concern. Another problem that must be addressed is that of ensuring that any new code provided to the peripheral is not corrupt or tainted.

### BRIEF DESCRIPTION OF THE DRAWINGS

FIG. 1 illustrates one example environment for use of an apparatus and method of the present invention.

FIG. 2 is a block diagram of a gaming machine in accordance with some embodiments of the present invention.

FIG. 3 is a block diagram of a peripheral device in accordance with an embodiment of the present invention.

FIG. 4A is schematic of a grouping of gaming machines such as illustrated in FIG. 2 in a simplified network arrangement.

FIG. 4B depicts a network that may be configured according to some implementations of the invention.

FIG. 4C is a block diagram of an Arbiter configured for communication with other devices in a gaming network.

FIG. 5 is a flow diagram illustrating a method in accordance with an embodiment of the invention.

FIG. 6 illustrates an operational flow diagram of a method of authenticating code that is provided to a peripheral in accordance with an embodiment of the invention.

FIG. 7 illustrates an exemplary format and content of a verification file.

FIGS. 8A and 8B illustrate an operational flow diagram of an example of a method of authentication of the invention.

FIG. 9 is a flow chart that outlines steps of some methods of the invention.

### EXAMPLES OF EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Overview

Among other things, the present invention provides for the downloading of code, including but not limited to peripheral device code, upon the occurrence of predetermined events. Such an event may sometimes be referred to herein as a “trigger,” a “triggering event” or the like. For example, a change in location of a gaming machine may comprise a trigger. Exceeding a predetermined number of errors within a predetermined time may comprise a trigger.

In some instances, the peripheral code that is downloaded in response to a triggering event may be different from the prior version of the peripheral code. For example, a change in the location and/or jurisdiction of a gaming machine may trigger a download of a version of peripheral code that is appropriate for the new location and/or jurisdiction, as described in more detail below.

Some implementations provide new peripheral device code each time a gaming machine initializes. Some embodiments provide peripheral devices with relatively small (or no) non-volatile memory.

A smaller non-volatile memory (as compared to prior art peripheral devices of the same type) may be possible because it is not necessary—and may not be desirable—to retain peripheral device code in non-volatile memory.

Some implementations of the invention provide methods and devices for downloading code or information to a peripheral device. As used herein, the term “code” generally means instructions and/or other data for use in controlling one or more functions of the peripheral or for operation of the peripheral. This code may comprise executable control code for controlling the operation of the device, and may also comprise operational information such as video data (such as for generation of images) or sound data (for use in generating sound) for use by the device. In one or more embodiments, the code or data may comprise an image file, i.e., the code or data in binary form. Thus, when steps of downloading, authenticating and the like are referred to herein, such actions may apply to the image file comprising the code/data.

Some embodiments of the invention provide a peripheral device for a gaming machine that includes the following elements: an interface configured for communication with a gaming machine; a volatile memory; and at least one logic device. The logic device is configured to determine when first peripheral code is received from the gaming machine. The logic device is further configured to load the first peripheral code in the volatile memory and to control functionality of the peripheral device according to the first peripheral code.

The use of an ordinal number such as “first” in this context does not necessarily indicate, e.g., that the peripheral code was literally the first to be received by the peripheral device. Instead, such ordinal numbers are often used herein (particularly in the claims) to make a distinction between two similar elements. Depending on the context, this distinction may or may not indicate a temporal sequence. Moreover, in some instances a “first” element may be identical, or substantially identical, to a “second,” “third” or “N^{th}” element.

The peripheral device may be configured to receive new peripheral code each time the peripheral device initializes. The first peripheral code may be purged from the volatile memory when the peripheral device powers down. The interface may comprise a Universal Serial Bus (“USB”) interface. The logic device may comprise a microcontroller selected from the EZ-USB™ microcontroller family.

The logic device may be configured to perform the following steps when the peripheral device re-initializes: determine when second peripheral code is received from the gaming machine; load the second peripheral code in the volatile memory; and control functionality of the peripheral device according to the second peripheral code.

The logic device may be configured to detect a potential triggering event and to send corresponding event data to the gaming machine. The logic device may also be configured to perform the following steps: determine when second peripheral code is received from the gaming machine; and, when the logic device determines that the peripheral device has received second peripheral code from the gaming machine, purge the first peripheral code from the volatile memory; load the second peripheral code in the volatile memory; and control functionality of the peripheral device according to the second peripheral code.

The peripheral device may comprise a non-volatile memory, preferably of sufficient size for storing a boot program. At least one logic device may be configured to store state information in the non-volatile memory.

Some embodiments of the invention provide a gaming machine that includes the following elements: means for providing wagering games, the providing means comprising a plurality of peripheral devices; a network interface; and at least one logic device. The logic device(s) may be configured to perform the following tasks: determine when first peripheral code received via the network interface; provide the first peripheral code to a first peripheral device; and detect a possible triggering event that may require new peripheral code for the first peripheral device. A logic device may comprise a USB controller and at least one port configured for communication with the first peripheral device.

At least one logic device may be configured to determine whether the possible triggering event requires new peripheral code for the first peripheral device. A logic device may be further configured to request a download of second peripheral code when it is determined that the event comprises a triggering event.

At least one logic device may also be configured to cause event data regarding the possible triggering event to be sent to a second device that is configured to determine whether the possible triggering event requires new peripheral code for the first peripheral device. The second device may be a server, a host device, another gaming machine, a kiosk, etc.

Some methods of the invention include the following steps: receiving first peripheral code; loading the first peripheral code in a memory of a peripheral device of a gaming machine; controlling the peripheral device according to the first peripheral code to provide a feature relating to wagering games presented on the gaming machine; detecting an event; and determining whether to download second peripheral code based, at least in part, on whether the event comprises a triggering event. The first peripheral code may be deleted when the peripheral device powers down.

The detecting step may be performed by the peripheral device, by the gaming machine or by another device. Event data may be sent from the gaming machine to a second device. If so, the second device may perform the determining step. The second device may comprise a server, a kiosk, a host device, another gaming machine. etc.

When the detecting step is performed by the peripheral device, event data may be transmitted from the peripheral device to the gaming machine. The gaming machine may perform the determining step. However, the event data may be sent from the gaming machine to another device that performs the determining step.

The receiving step may be performed by the gaming machine. The method may further comprise the step of authenticating the first peripheral code by the gaming machine prior to loading the first peripheral code in the memory of the peripheral device.

When it is determined that the potential triggering event is an actual triggering event, the method may further comprise these steps: receiving the second peripheral code; loading the second peripheral code in the memory; and controlling the peripheral device according to the second peripheral code.

For example, the event may comprise a power fluctuation and the determining step may comprise determining whether the power fluctuation exceeds predetermined parameters. The event may involve an elapsing of a period of time, an indication of an attempted access to the interior of the gaming machine, a CRC failure, an audit request, a relocation of the gaming machine, a reconfiguration of the gaming machine, a release of new peripheral code and/or a change in at least one regulatory requirement.

Accordingly, the determining step may comprise determining that a predetermined number of errors has been exceeded, determining that a predetermined transaction has been requested, determining that a predetermined number of operations has been exceeded, etc. The operations may, for example, comprise financial transactions involving at least a predetermined monetary amount.

The first peripheral code may be deleted from the memory when the gaming machine powers down. The peripheral device may be provided with new peripheral code after each time the gaming machine initializes.

Alternative methods of the invention involve operating a gaming device, including a game device controller and at least one peripheral having a peripheral controller associated with said game device controller. The methods comprising the following steps: initiating operation of said gaming device; transmitting a signal from said peripheral device to said game device controller causing said game device controller to provide control code to said peripheral device; authenticating said control code; transmitting said control code to said peripheral device; storing said control code at said programmable memory of said peripheral device; and executing said control code with said peripheral controller for effecting operation of said peripheral device.

Alternative gaming devices for presenting a game for play to a player are also provided herein. Some such gaming devices comprise the following elements: at least one game control device; at least one peripheral device associated with said game control device; a peripheral controller for controlling said peripheral device; resident code adapted to cause said peripheral controller to obtain control code for controlling the operation of said peripheral device; programmable data storage for storing control code transmitted to said peripheral device in response to a signal provided to said game control device.

The present invention provides other hardware (such as network devices and components of network devices) that is configured to perform the methods of the invention, as well as software to control devices to perform these methods. The method and apparatus of the invention may be implemented in a wide variety of environments generally comprising “computing” environments, such as personal desktop and laptop computers and electronically and electro-mechanically controlled devices for presenting games.

### DETAILED EXAMPLES

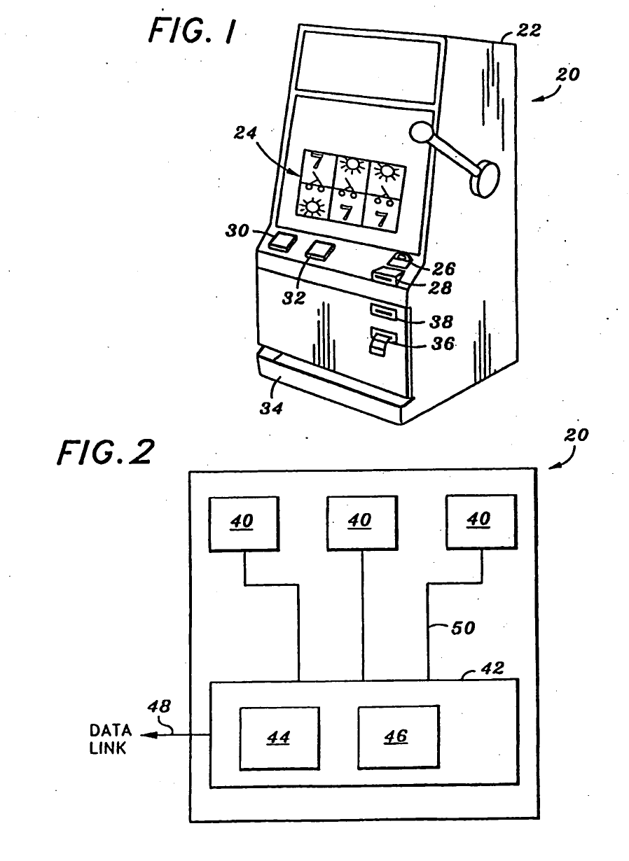

FIG. 1 illustrates the preferred environment to which the invention is applied, that of an electronic gaming device 20. The gaming device 20 illustrated in FIG. 1 is illustrated as but one example of a device with which the invention is useful. As illustrated, the electronic gaming device 20 includes a cabinet 22 housing a display 24. The display 24 may comprise a video display or one or more mechanically or electro-mechanically controlled devices, such as reels. The display 24 comprises one peripheral of the gaming device 20.

In one embodiment of such a gaming device 20, a player is permitted to play a game once a bet has been placed. In order to place a bet, the player must first provide credit in the form of monies or other elements of value as required by the game operator. In the embodiment illustrated, the gaming device 20 includes a coin acceptor 26 for accepting one or more coins, tokens or the like. In general, the coin acceptor comprises another peripheral device, and may have at least the function of validating presented coins and indicating the value of the accepted coins. The device 20 illustrated also includes a bill validator 28 for accepting paper currency, tickets or the like. The bill validator 28 is yet another peripheral device, and may have at least the function of validating the presented bill monies and indicating the value of the accepted bills.

Once the player has provided the appropriate credit, the player is permitted to place a bet. In one embodiment, the device 20 includes a bet button 30 for indicating the desired bet to be placed. Once a bet is placed, the player is permitted to start the game. In the embodiment illustrated, the game involves the rotation of displayed reels. The player depresses a spin button 32, and the display 24 is caused to display images of rotating reels. This plurality of buttons may be arranged as a peripheral device. Additionally, in the case of electro-mechanical arrangement of rotating reels, these reels may be arranged as a peripheral device. These concepts (downloadable peripherals) may be applied to both video as well as spinning reel type gaming machines.

A player may be paid a winning if the outcome of the game is a particular predetermined outcome as displayed by the display 24. These winnings may be paid by a coin dispenser (not shown) to a coin tray 34. Alternately, the player may be paid winnings in the form of a ticket dispensed by a ticket generator 36. The ticket generator 36 is a peripheral arranged to print a ticket.

Many gaming devices, such as that illustrated, include a card reader 38 for reading information from a player card. This information may be used in a player tracking system, as is well known in the art.

In general, it will be appreciated that a gaming device 20 such as illustrated may include a variety of peripheral devices. These devices may include those described above and/or a wide variety of other devices. It will be appreciated that the present invention is applicable to gaming devices 20 such as that illustrated, and gaming devices arranged to present a wide variety of other games. One or more aspects of the present invention are applicable to devices other than gaming devices to the extent such devices include a computing environment with at least one peripheral associated with a controller or processor. For example, the invention may be applied to machines or devices used in support of gaming machines 20, such as cash validation terminals, progressive controllers and the like. Other peripheral devices to which the invention may be applied include player tracking units, coin hoppers, printers (dot matrix, thermal or the like), top boxes, light displays, sound systems, reader boards, touch screen controllers, communication devices (modems, Ethernet cards, wireless controllers), secondary video display devices, and button and light/lamp controllers. For example, the code that is provided to a light display may comprise data files for generating images, and the code that is provided to a sound system may include sound files.

Referring now to FIG. 2, one or more peripheral devices 40, such as those of a gaming machine 20, are controlled by one or more gaming device controllers, such as a master gaming controller 42. In one or more embodiments, the master gaming controller 42 includes a processor 44 and a memory for storing data. In a preferred embodiment, the master gaming controller 42 includes a memory in the form of at least one data mass storage device 46. In one embodiment, the mass storage device 46 is capable of storing data comprising peripheral executable or operational code. As is well known, the mass storage device(s) 46 may comprise a wide variety of devices and mediums capable of storing electronic data, such as hard drives, CD-ROM, floppy discs, tapes, flash memory, RAM and the like. Preferably, these storage devices and remote storage elements employ security and authentication algorithms and hardware to insure the integrity of stored information, such as to ensure the authenticity of the code as described below.

In some preferred implementations, peripheral devices 40 provide little or no security/authentication functionality. Such implementations allow the amount of non-volatile memory and processing power to be relatively smaller than implementations wherein peripheral devices 40 provide more significant security/authentication functionality.

In one embodiment, a communications or data link 48 is provided between the master gaming controller 42 and another device. The other device may comprise a remote server or computer. The data link 48 permits transmission of data to and/or from the master gaming controller 42. The data link 48 may comprise a wired or wireless communications link, e.g., serial, parallel, Ethernet, Token Ring, Firewire®, etc. As stated above, the data link 48 may be useful in transmitting player tracking or similar information regarding play of the gaming device 20 to a remote location. Moreover, data link 48 may be used for communications involving downloads of game code, peripheral code, etc.

Appropriate input/output controllers and devices are provided for permitting data to flow to and from the processor 44 of the master gaming controller 42. In one or more embodiments, at least one bus (not shown) is provided for this purpose. In one or more embodiments, additional hardware and/or software may be provided for permitting communications with the master gaming controller 42 through the data link 48. The protocol is preferably one that facilitates high-speed communication, such as the proprietary “SPC” protocol provided by IGT. However, various other protocols may be used. For example, data may be transmitted through the link 48 using an IEEE-1394 protocol/architecture.

In such an embodiment, a physical card including at least one port may be associated with the bus. This card may include hardware and/or software embodying the IEEE-1394 protocol, including physical, link and other layers as defined thereby. The port may be arranged to accept a network wire or cable. In this manner, data may be transmitted from the controller 42 to a remote location, or vice versa, over the link 48. In one or more embodiments, the data may be transmitted in accordance with an Ethernet or TCP/IP protocol, as enabled through a physical card or on-board communications port.

As illustrated, one or more peripherals 40 are associated with the master gaming controller 42. At least one communications or data link 50 is provided between each peripheral 40 and the master gaming controller 42. In one embodiment, the communications link 50 permits data to be transferred between the processor 44 of the master gaming controller 42 and each peripheral 40 via the system bus of the master gaming controller 42. Again, this link may comprise a wired or wireless communications pathway.

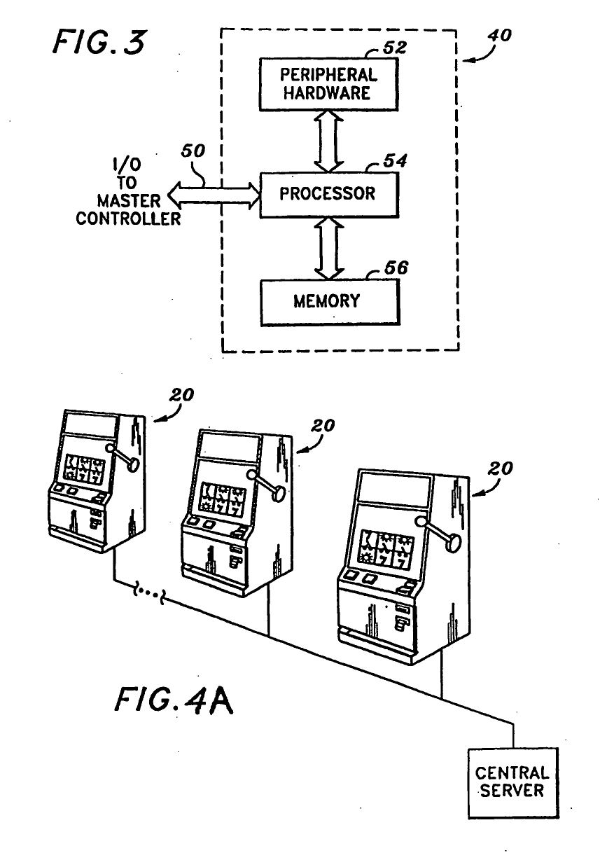

An embodiment of a peripheral 40 in accordance with the invention will be described with reference first to FIG. 3. As illustrated therein, in one or more embodiments, the peripheral includes hardware 52. The specific hardware 52 may vary depending upon the nature of the functions to be performed by the peripheral 40. For example, in the case of a bill validator, the hardware may include bill transport and scanning apparatuses.

The peripheral 40 also includes logic device such as a processor or controller 54 and at least one data storage device such as a memory 56, which may or may not include non-volatile memory. As mentioned elsewhere herein, some implementations of the invention provide relatively small amounts of non-volatile memory or none at all, where possible.

Preferred embodiments of the invention provide at least a small amount of non-volatile memory for storing at least an initialization program, also known as a “boot” program. Such a boot program should reliably boot up when power is applied to peripheral 40 and should be ready to communicate with a host machine even without any other programs present. The boot program should be able to receive a download of peripheral code (e.g., from the host machine) and will preferably be able to detect corruption of data in the download of application firmware from the host machine. In some implementations, such a boot program may authenticate downloads of peripheral code, but in preferred implementations authentication is provided by one or more other devices, e.g., by the host machine. In some implementations, the boot program cannot be updated from a host machine to prevent corruption during download. However, in some implementations the boot program can be updated in-circuit through a JTAG connector and/or can be authenticated out of circuit.

In one embodiment, the processor 54 includes at least one bus (not shown) that permits communication with the peripheral hardware 52 and the memory 56. In general, operation of the peripheral 40, including the peripheral hardware 52, is controlled by code that is processed by the processor 54.

In accordance with some implementations of the present invention, at least a portion of the peripheral control code can be changed, such as by update or complete replacement. In a preferred embodiment, the peripheral code is downloadable to the peripheral 40, eliminating the need for direct physical contact other than that provided by the wired or wireless link 50 of the peripheral 40 in order to change its control code. In some embodiments, peripheral control or executable code is provided from a location outside gaming machine 20. The code is preferably provided via data link 48 and master gaming controller 42 through the communications link 50.

In the embodiment where the code is associated with a memory 56, the memory is preferably of the programmable or re-writeable type. In other words, the memory may store first data (e.g., first peripheral code), and then later store second data (e.g., first peripheral code) at least in part in replacement of the first data. As described in more detail below, such memory 56 may comprise one or more of a variety of types of memory devices or modules.

In some configurations of the invention, the peripheral controller 54 comprises a microcontroller selected from the EZ-USB™ microcontroller family available from Cypress Semiconductor Corporation of San Jose, Calif., or is similarly arranged. Although other protocols may be used, in this embodiment the master gaming controller 42 includes a Universal Serial Bus (USB) to which the peripheral 40 is connected. In this arrangement, a USB may be associated with the bus of the master gaming controller 42. The USB may include hardware and software, including a USB controller and at least one port for connection of a communication cable through which data may flow between the peripheral 40 and master gaming controller 42. The protocol and architecture of a USB is well known and will not be described herein. Such information may be found in the text USB Hardware and Software, ISBN 0-929392-37-X, which is incorporated herein by reference.

The following applications describe relevant subject matter and are hereby incorporated by reference: U.S. patent application Ser. No. 10/460,822, filed on Jun. 11, 2003 and entitled “USB SOFTWARE ARCHITECTURE IN A GAMING MACHINE,” which claims priority under U.S.C. 120 from U.S. patent application Ser. No. 10/246,367, filed on Sep. 16, 2002, and entitled, “USB DEVICE PROTOCOL FOR A GAMING MACHINE,” which is a continuation-in-part from U.S. patent application Ser. No. 10/214,255, filed on Aug. 6, 2002, titled “STANDARD PERIPHERAL COMMUNICATION”, which is a continuation of U.S. patent application Ser. No. 09/635,987, titled “STANDARD PERIPHERAL COMMUNICATION” filed on Aug. 9, 2000, which is a divisional application from U.S. patent application Ser. No. 09/414,659, titled “STANDARD PERIPHERAL COMMUNICATION” filed on Oct. 6, 1999, which is now U.S. Pat. No. 6,251,014.

In such an embodiment, the peripheral controller/processor 54 may include, among other things, a control chip or interface engine/processor (which would comprise a USB interface engine in this example), an internal memory, a data bus, and an address bus. The processor may be pre-programmed or coded to perform reset and enumeration functions. In accordance with these functions, when power is applied to the controller 54, a reset function may be held in an asserted state, preventing the controller from executing other instructions. At the same time, the controller 54 is identified on the USB as a download type device. In response to this identification, the master gaming controller 42 is preferably adapted to obtain peripheral control code for the peripheral 40 and send it to the peripheral 40 via the communication link 50. As described in more detail below, this code may be stored at the mass storage 46 of the master controller 42, and/or be stored at a remote location. In the event the code is stored at a remote location, the master gaming controller 42 first obtains the code and then sends it to the peripheral 40. As described in more detail below, in some embodiments, before the code is transmitted to the peripheral 40, it is authenticated.

The master controller 42 provides the peripheral control code to the peripheral 40. In this embodiment, direct memory access is preferably provided, such that the code is stored directly to the memory 56 without intervention by the controller 54. In other embodiments, the code may first be provided to the controller 54 and/or a local memory thereof, and then be forwarded for storage to the memory 56. Once the code has been downloaded and stored, a command is sent to the USB interface engine forcing the controller 54 to disconnect from the USB. At this time, the controller 54 reset function is released and the controller 54 begins executing the code that was downloaded and stored in the memory 56. Preferably, when executed, the downloaded code initializes the peripheral 40 and enables the peripheral 40 to enumerate itself as a particular device. Once this has occurred, the USB interface engine reconnects to the USB and now identifies itself as a particular device, i.e. a bill validator, coin acceptor or the like. During the remainder of a session, the peripheral 40 is enabled to be used as part of the gaming device 20.

In an embodiment where the peripheral controller 54 comprises an EZ-USB™ type device, the controller 54 may include a number of other features. For example, the controller 54 may include an I²C™ controller that communicates with the USB engine through a data bus. This controller is adapted to permit local communications, as is well known.

In this embodiment, the peripheral 40 may include two memory devices. In one embodiment, the peripheral 40 may include an internal memory, such as 4 or 8 Kb of RAM. This internal memory may be associated directly with the controller 56 and include a code for performing the reset and other functions described above. In some embodiments of the invention, the memory 56 is external and is in addition to an internal memory. In one embodiment, the memory 56 comprises 32 Kb, 64 Kb or more of additional memory. As described elsewhere herein, the exact type of memory may vary.

In another embodiment of the invention, the peripheral controller 54 again includes a processor and memory. Fixed code is resident at the peripheral 40. This code may be embedded in hardware, such as part of a control chip, or stored in the memory 56. In response to an identification inquiry from the processor 44 or other device associated with the master gaming controller 42, the fixed or resident code is arranged to cause the peripheral controller 54 to cause the master gaming controller 42 to download peripheral control code in like manner to that described above.

In this embodiment, the peripheral controller 54 may be associated with the master gaming controller 42 in a wide variety of manners. For example, the communication link 50 may be provided by other means or protocols than USB, such as a serial connection, including serial RS-232 and RS-422, or a parallel connection.

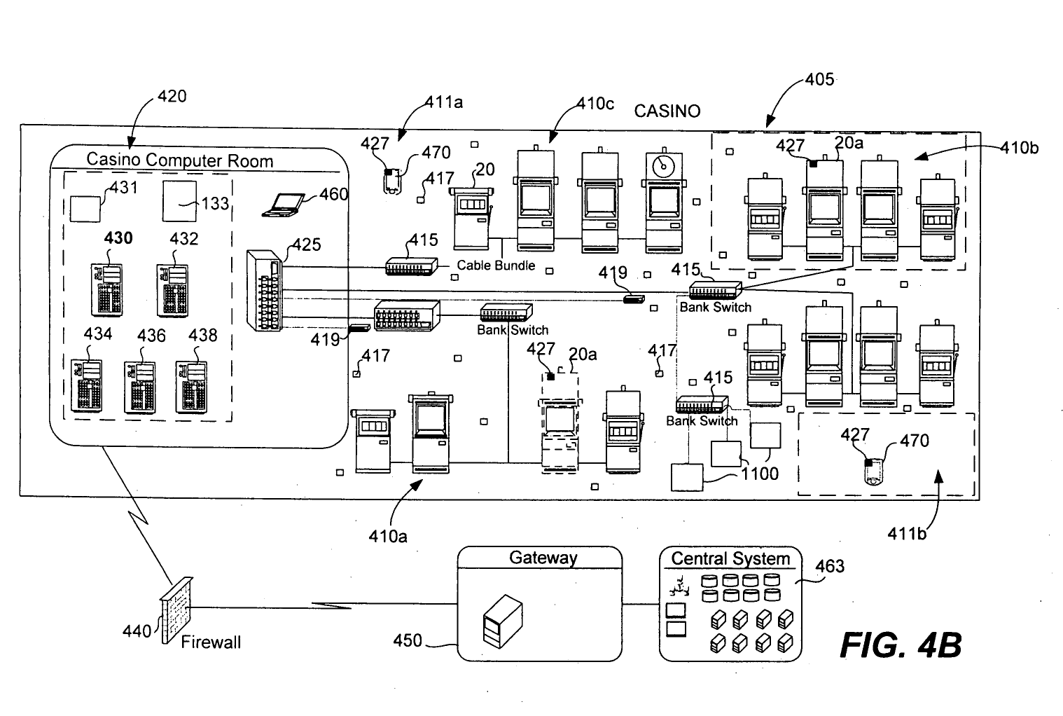

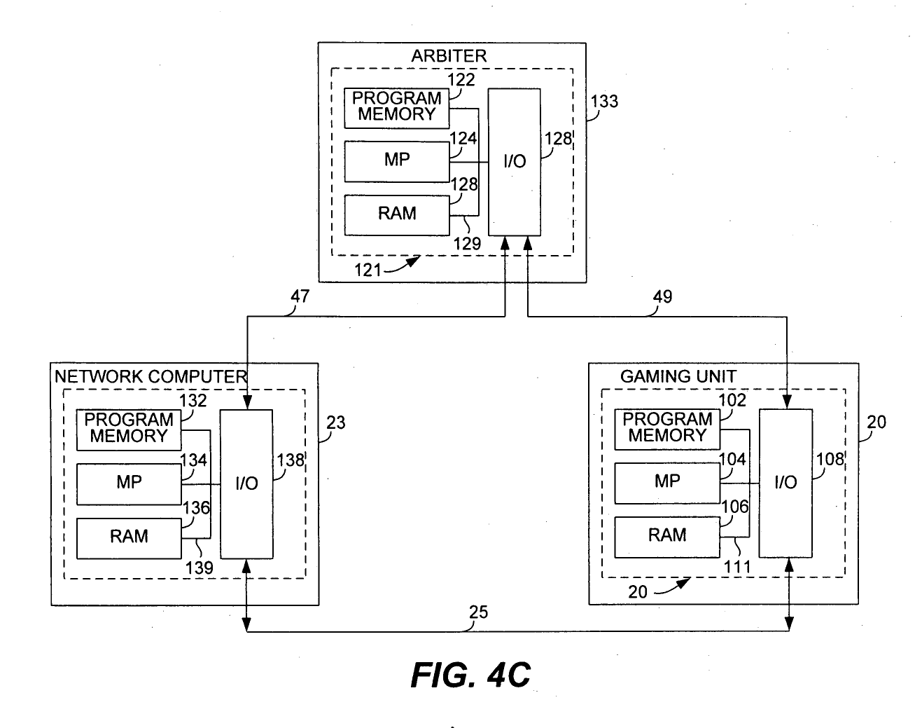

As stated above, in some embodiments of the invention, peripheral code is provided by the master gaming controller 42. In one embodiment, the code is stored at the mass storage 46 of the master gaming controller 42. In another embodiment, as illustrated in FIGS. 4A-4C, the code may be stored at a remote location, such as a central server. In the embodiment illustrated in FIG. 4A, the master gaming controller 42 (shown in FIG. 2) associated with several gaming machines 20 is in communication with the central server via one or more communication links.

Some gaming networks described herein allow for the convenient provisioning of networked gaming machines and allow additional game themes to be easily and conveniently added or changed, if desired. Related software, including but not limited to game software and peripheral software, may be downloaded to networked gaming machines.

Relevant information is set forth in U.S. patent application Ser. No. 11/225,407 (Attorney Docket No. IGT1P237/P-1051), by Wolf et al., entitled “METHODS AND DEVICES FOR MANAGING GAMING NETWORKS” and filed Sep. 12, 2005, in U.S. patent application Ser. No. 10/757,609 by Nelson et al., entitled “METHODS AND APPARATUS FOR GAMING DATA DOWNLOADING” (Attorney Docket No. IGT1P213/P-657) and filed on Jan. 14, 2004, in U.S. patent application Ser. No. 10/938,293 by Benbrahim et al., entitled “METHODS AND APPARATUS FOR DATA COMMUNICATION IN A GAMING SYSTEM” (Attorney Docket No. IGT1P199/P-909) and filed on Sep. 10, 2004, in U.S. patent application Ser. No. 11/225,337 (Attorney Docket No. IGT1P185/P-1017) by Nguyen et al., filed Sep. 12, 2005 and entitled “DISTRIBUTED GAME SERVICES” and in U.S. patent application Ser. No. 11/173,442 (Attorney Docket No. IGT1P153/P-991) by Kinsley et al., filed Jul. 1, 2005 and entitled “METHODS AND DEVICES FOR DOWNLOADING GAMES OF CHANCE,” all of which are hereby incorporated by reference in their entirety and for all purposes. Some examples of gaming networks and devices are set forth below.

One example of a network topology for implementing some aspects of the present invention is shown in FIG. 4B. Those of skill in the art will realize that this architecture and the related functionality are merely examples and that the present invention encompasses many other such embodiments and methods. Here, a single gaming establishment 405 is illustrated, which is a casino in this example. However, it should be understood that some implementations of the present invention can involve multiple gaming establishments.

Gaming establishment 405 includes multiple gaming machines 20, each of which is part of a bank 410 of gaming machines 20. In this example, gaming establishment 405 also includes a bank of networked gaming tables 1100. It will be appreciated that many gaming establishments include hundreds or even thousands of gaming machines 20 and/or gaming tables 1100, not all of which are included in a bank. However, the present invention may be implemented in gaming establishments having any number of gaming machines, gaming tables, etc.

In this example, each bank 410 has a corresponding bank switch 415, which may be a conventional bank switch. Each bank switch is configured for communication with one or more devices in computer room 420 via main network device 425, which combines switching and routing functionality in this example. Although various floor communication protocols may be used, some preferred implementations use IGT's open, Ethernet-based SuperSAS® protocol, which IGT makes available for downloading without charge. However, other protocols such as Best of Breed (“BOB”), Game to System (“G2S”), etc., may be used to implement various aspects of the invention. IGT has also developed a gaming-industry-specific transport layer called CASH that rides on top of TCP/IP and offers additional functionality and security.

Here, gaming establishment 405 includes a plurality of location detection devices 417, which are RFID readers in this example. In this example, location detection devices 417 are configured for communication with at least one of network devices 419, which are RFID switches in this example. In some embodiments, at least some of network devices 419 and/or switches 415 may comprise wireless access points to facilitate communication with wireless devices such as mobile gaming devices 470. RFID switches 419 are configured for communication with one or more devices in computer room 420 via main network device 425. For example, one of the servers in computer room 420 (or a blade of a blade server) may be dedicated to functions relating to the RFID network (or other location detection network). In alternative embodiments, location detection devices 417 may be triangulation devices, devices for enabling GPS in an interior space (such as repeaters), or other location detection devices known in the art. The number and spacing of location detection devices 417 may vary according to the implementation.

In this example, gaming machines 20 and mobile gaming devices 470 each include at least one RFID tag 427 that includes identification information corresponding with the device. For example, gaming machine 20a may include one or more RFID tags 427 that indicate its identity. The RFID tag(s) 427 may indicate information regarding the manufacturer, model and serial number of the gaming machine and of associated devices, including peripheral devices. When gaming machine 20a is moved from bank 410a to bank 410b, various RFID readers 417 will read the RFID tags 427 and relay this information to one of the servers in computer room 420. Therefore, a change in location of the gaming machine may be determined. A change in location of gaming machine 20a may also be determined according to a change in the bank switch 415 to which gaming machine 20a is connected.

When mobile gaming device 470 is moved from area 411a to area 411b, RFID readers 417 along the way will read the RFID tag(s) 427 of mobile gaming device 470 and relay this information to one of the servers in computer room 420. In this manner, a change in location of the mobile gaming device may be determined.

It may be desirable to change at least some aspect of software used by a gaming machine or mobile gaming device in accordance with a change in location. For example, bank 410b may be a “high roller” area in which higher denominations are used than in gaming machines of bank 410a. Therefore, a different type of software may be desirable for a bill acceptor or the like in the high roller area. Some areas of a gaming establishment may have restrictions as to the game class that can be played. For example, Class III game play may be restricted to a particular area of a casino. In other areas of a gaming establishment, wagering may not be permitted at all. For example, area 411b may be an arcade area where only non-wagering games may be played. If that were the case, mobile gaming device 470 should preferably not be configured to provide wagering games when it is determined that mobile gaming device 470 is in area 411b. Similarly, if a gaming machine or mobile gaming device is moved to another jurisdiction, in some implementations of the invention the functionality of the device will change according to the jurisdiction.

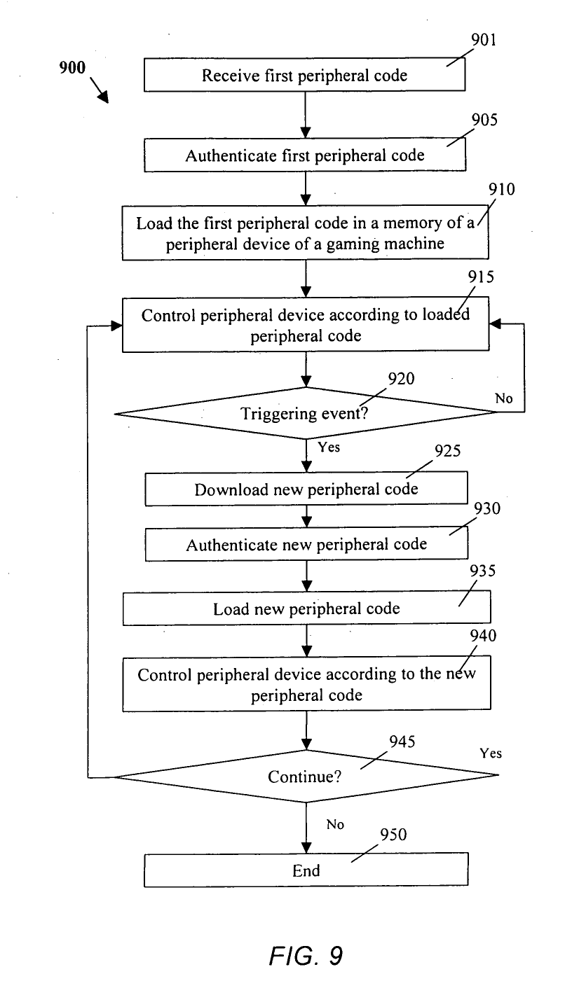

As discussed in more detail elsewhere herein, a location change is one example of what will sometime be referred to herein as a “trigger” that may cause the provisioning of new software, including but not limited to peripheral device software, and/or the enabling or disabling of device features. Alternatively, such a trigger may cause a determination of whether such provisioning, enabling or disabling may be required. Various other triggers will be discussed below with reference to FIG. 9.

Various alternative network topologies can be used to implement different aspects of the invention and/or to accommodate varying numbers of networked devices. For example, gaming establishments with very large numbers of gaming machines 20 may require multiple instances of some network devices (e.g., of main network device 425, which combines switching and routing functionality in this example) and/or the inclusion of other network devices not shown in FIG. 4B. For example, some implementations of the invention include one or more middleware servers disposed between RFID switches 419 and/or bank switches 415 and one or more devices in computer room 420 (e.g., a corresponding server). Such middleware servers can provide various useful functions, including but not limited to the filtering and/or aggregation of data received from switches, from individual gaming machines and from other player terminals. Some implementations of the invention include load balancing methods and devices for managing network traffic.

SBG server 430, License Manager 431, Arbiter 133, servers 432, 434, 436 and 438, and main network device 425 are disposed within computer room 420 of gaming establishment 405. In practice, more or fewer servers may be used. Some of these servers may be configured to perform tasks relating to player tracking, bonusing/progressives, etc. Some servers may be configured to perform tasks specific to the present invention, including but not limited to downloading peripheral device software to gaming machines. License Manager 431 may also be implemented, at least in part, via a server or a similar device. Some exemplary operations of License Manager 431 are described in detail in U.S. patent application Ser. No. 11/225,408 (Attorney Docket No. IGT1P253), entitled “METHODS AND DEVICES FOR AUTHENTICATION AND LICENSING IN A GAMING NETWORK” by Kinsley et al., which is hereby incorporated by reference.

Some preferred embodiments of SBG server 430 and the other servers shown in FIG. 4B include (or are at least in communication with) clustered CPUs, redundant storage devices, including backup storage devices, switches, etc. Such storage devices may include a redundant array of inexpensive disks (“RAID”), back-up hard drives and/or tape drives, etc. Preferably, a Radius and a DHCP server are also configured for communication with the gaming network. Some implementations of the invention provide one or more of these servers in the form of blade servers.

In some implementations of the invention, many of these devices (including but not limited to License Manager 431, servers 432, 434, 436 and 438, and main network device 425) are mounted in a single rack with SBG server 430. Accordingly, many or all such devices will sometimes be referenced in the aggregate as an “SBG server.” However, in alternative implementations, one or more of these devices is in communication with SBG server 430 and/or other devices of the network but located elsewhere. For example, some of the devices could be mounted in separate racks within computer room 420 or located elsewhere on the network. For example, it can be advantageous to store large volumes of data elsewhere via a storage area network (“SAN”).

Computer room 420 may include one or more operator consoles or other host devices that are configured for communication with other devices within and outside of computer room 420. Such host devices may be provided with software, hardware and/or firmware for implementing various aspects of the invention. However, such host devices need not be located within computer room 420. Wired host device 460 (which is a laptop computer in this example) and wireless host device (which is a PDA in this example) may be located elsewhere in gaming establishment 405 or at a remote location.

Arbiter 133 may be implemented, for example, via software that is running on a server or another networked device. Arbiter 133 serves as an intermediary between different devices on the network. Some implementations of Arbiter 133 are described in U.S. patent application Ser. No. 10/948,387, entitled “METHODS AND APPARATUS FOR NEGOTIATING COMMUNICATIONS WITHIN A GAMING NETWORK” and filed Sep. 23, 2004 (the “Arbiter Application”), which is incorporated herein by reference and for all purposes. In some preferred implementations, Arbiter 133 is a repository for the configuration information required for communication between devices on the gaming network (and, in some implementations, devices outside the gaming network). Although Arbiter 133 can be implemented in various ways, one exemplary implementation is discussed in the following paragraphs.

FIG. 4C is a block diagram of a simplified communication topology between gaming unit 20, network computer 23 and Arbiter 133. Network computer 23 may be, for example, a server or other device within computer room 420 or elsewhere. Although only one gaming unit 20, one network computer 23 and one Arbiter 133 are shown in FIG. 4C, it should be understood that the following examples may be applicable to different types of networked devices in addition to gaming unit 20 and network computer 23, and may include different numbers of network computers, gaming security arbiters and gaming units. For example, a single Arbiter 133 may be used for secure communications among a plurality of network computers 23 and tens, hundreds or thousands of gaming units 20. Likewise, multiple gaming security arbiters 46 may be utilized for improved performance and other scalability factors.

Referring to FIG. 4C, the Arbiter 133 may include an arbiter controller 121 that may comprise a program memory 122, a microcontroller or microprocessor (MP) 124, a random-access memory (RAM) 126 and an input/output (I/O) circuit 128, all of which may be interconnected via an address/data bus 129. The network computer 23 may also include a controller 131 that may comprise a program memory 132, a microcontroller or microprocessor (MP) 134, a random-access memory (RAM) 136 and an input/output (I/O) circuit 138, all of which may be interconnected via an address/data bus 139. It should be appreciated that although the Arbiter 133 and the network computer 23 are each shown with only one microprocessor 124, 134, the controllers 121, 131 may each include multiple microprocessors 124, 134. Similarly, the memory of the controllers 121, 131 may include multiple RAMs 126, 136 and multiple program memories 122, 132. Although the I/O circuits 128, 138 are each shown as a single block, it should be appreciated that the I/O circuits 128, 138 may include a number of different types of I/O circuits. The RAMs 124, 134 and program memories 122, 132 may be implemented as semiconductor memories, magnetically readable memories, and/or optically readable memories, for example.

Although the program memories 122, 132 are shown in FIG. 4C as read-only memories (ROM) 122, 132, the program memories of the controllers 121, 131 may be a read/write or alterable memory, such as a hard disk. In the event a hard disk is used as a program memory, the address/data buses 129, 139 shown schematically in FIG. 4C may each comprise multiple address/data buses, which may be of different types, and there may be an I/O circuit disposed between the address/data buses.

As shown in FIG. 4C, the gaming unit 20 may be operatively coupled to the network computer 23 via the data link 25. The gaming unit 20 may also be operatively coupled to the Arbiter 133 via the data link 49, and the network computer 23 may likewise be operatively coupled to the Arbiter 133 via the data link 47. Communications between the gaming unit 20 and the network computer 23 may involve different information types of varying levels of sensitivity resulting in varying levels of encryption techniques depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings, etc.), download information (e.g., game and/or peripheral software, licensing information, etc.) and personal information (e.g., social security number, personal preferences, etc.) may be encrypted with stronger encryption techniques such as DES or 3DES to provide increased security.

As disclosed in further detail in the Arbiter Application, the Arbiter 133 may verify the authenticity of each network gaming device. The Arbiter 133 may receive a request for a communication session from a network device. For ease of explanation, the requesting network device may be referred to as the client, and the requested network device may be referred to as the host. The client may be any device on the network and the request may be for a communication session with any other network device. The client may specify the host, or the gaming security arbiter may select the host based on the request and based on information about the client and potential hosts. The Arbiter 133 may provide encryption keys (session keys) for the communication session to the client via the secure communication channel. Either the host and/or the session key may be provided in response to the request, may have been previously provided. The client may contact the host to initiate the communication session. The host may then contact the Arbiter 133 to determine the authenticity of the client. The Arbiter 133 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, the Arbiter 133 may contact the host regarding the request and provide corresponding session keys to both the client and the host. The Arbiter 133 may then initiate either the client or the host to begin their communication session. In turn, the client and host may begin the communication session directly with each other using the session keys to encrypt and decrypt messages. An additional explanation of the communication request, communication response and key distribution is provided in the Arbiter Application.

If a host device is located in a remote location, security methods and devices (such as firewalls, authentication and/or encryption) should be deployed in order to prevent the unauthorized access of the gaming network. Similarly, any other connection between gaming network 1205 and the outside world should only be made with trusted devices via a secure link, e.g., via a virtual private network (“VPN”) tunnel. For example, the illustrated connection between SBG 1230, gateway 1250 and central system 1263 (that may be used for communications involving peripheral device software downloads, etc.) is advantageously made via a VPN tunnel. Details of VPN methods that may be used with the present invention are described in the reference, “Virtual Private Networks-Technologies and Solutions,” by R. Yueh and T. Strayer, Addison-Wesley, 2001, ISBN#0-201-70209-6, which is incorporated herein by reference and for all purposes. Additionally VPNs may be implemented using a variety of protocols, such as, for example, IP Security (IPSec) Protocol, Layer 2 Tunneling Protocol, Multiprotocol Label Switching (MPLS) Protocol, etc. Details of these protocols, including RFC reports, may be obtained from the VPN Consortium, an industry trade group (http://www.vpnc.com, VPNC, Santa Cruz, Calif.).

For security purposes, any information transmitted to or from a gaming establishment over a public network may be encrypted. In one implementation, the information may be symmetrically encrypted using a symmetric encryption key, where the symmetric encryption key is asymmetrically encrypted using a private key. The public key may be obtained from a remote public key server. The encryption algorithm may reside in processor logic stored on the gaming machine. When a remote server receives a message containing the encrypted data, the symmetric encryption key is decrypted with a private key residing on the remote server and the symmetrically encrypted information sent from the gaming machine is decrypted using the symmetric encryption key. A different symmetric encryption key is used for each transaction where the key is randomly generated. Symmetric encryption and decryption is preferably applied to most information because symmetric encryption algorithms tend to be 100-10,000 faster than asymmetric encryption algorithms.

As mentioned elsewhere herein, U.S. patent application Ser. No. 11/225,408 (Attorney Docket No. IGT1P253), entitled “METHODS AND DEVICES FOR AUTHENTICATION AND LICENSING IN A GAMING NETWORK” by Kinsley et al., describes novel methods and devices for authentication, downloading and license management. This application has been incorporated herein by reference.

Providing a secure connection between the local devices of the gaming network 405 and central system 463 allows for the deployment of many advantageous features. For example, a customer (e.g., an employee of a gaming establishment) can log onto an account of central system 1263 to obtain the account information such as the customer's current and prior account status. Automatic updates of a customer's software may also be enabled. For example, central system 1263 may notify one or more devices in gaming establishment 405 regarding new products and/or product updates. For example, central system 1263 may notify server (or other device) in computer room 420 regarding new software, software updates, the status of current software licenses, etc. Alternatively, such updates could be automatically provided to a server in computer room 420 and downloaded to networked gaming machines.

After the local server receives this information, relevant products of interest may be identified (by the server, by another device or by a human being). If an update or a new software product is desired, it can be downloaded from the central system. Similarly, a customer may choose to renew a software license via a secure connection with central system 1263, e.g., in response to a notification that the software license is required.

In addition, providing secure connections between different gaming establishments can enable alternative implementations of the invention. For example, a number of gaming establishments may be owned and/or controlled by the same entity. In such situations, having secure communications between gaming establishments makes it possible for a gaming entity to use one or more servers in a gaming establishment as an interface between central system 1263 and gaming machines in multiple gaming establishments. For example, new or updated peripheral device software may be obtained by a server in one gaming establishment and distributed to gaming machines in that gaming establishment and/or other gaming establishments.

In an embodiment where the code is stored at a remote location, the master gaming controller 42 may be arranged to obtain the code in response to an instruction/identification by the peripheral controller 54, by master gaming controller 42, by a device (e.g., a server) in computer room 420, or by another device. In the event the peripheral controller 54 requests the code, such as by identifying itself as a download device, the master gaming controller 42 may be arranged to send a request for the code to the remote device, causing the remote device to transmit the code. This code may be stored at the mass storage 46 of the master gaming controller 42 or in a volatile memory, such as RAM. The master gaming controller 42 may then re-transmit the code on to the peripheral 40. In one embodiment, the code may be stored at a remote code repository, and transferred to a local system and then the gaming device 20 or directly to the gaming device. Firmware may be provided which allows the operator to designate the source and manner of obtaining the code.

The memory 56 of the peripheral 40 may comprise a wide variety of elements such as static RAM, Dynamic RAM, Synchronous Dynamic RAM, FLASH ROM and EPROM. In a preferred arrangement of the invention, the memory 56 associated with the peripheral 40 comprises one or more static RAM chips or similar elements, rather than EPROM or FLASH ROM device. When information is stored to an EPROM or FLASH ROM, complex algorithms must be performed to write the data to the device. On the other hand, data may be written to the static RAM using a simple bus write cycle. This permits data to be written to the peripheral 40 in a much faster fashion. For example, the difference in write time may be nanoseconds versus milliseconds. In the gaming environment, this write time is very important. First, during transmission of the code, the download process is susceptible to interruption and interference. This may corrupt the code, requiring that the code be re-transmitted. The additional time required to write or store the code also limits the maximum rate of transmission. In the event code is simultaneously forwarded from the master gaming controller 42 to several peripherals 40, these delays increase the time the gaming device 20 is not operational. During a long transmission cycle, the opportunity for interception of the data also increases. This increases the likelihood that a party may intercept the code and retransmit unauthentic code to the peripheral device 20.

In one or more embodiments, the peripheral memory 56 at which the control code is stored is a volatile memory that loses its ability to store data upon the occurrence of one or more events. In one embodiment, the memory is of a type which loses is ability to store data when power is interrupted thereto. In accordance with this embodiment, in the event of an interruption in power, the peripheral's control code is effectively erased, necessitating that the control code be obtained again. This arrangement has several benefits. During a power interruption, the security of the gaming device 20 may be compromised. Even if a party attempts to tamper with a peripheral 40 of the device 20, when power is again provided to the device, the control code for each peripheral 40 is reloaded from an authentic source (or is authenticated, as described in greater detail below), ensuring that the peripheral 40 operates as desired.

In addition, the master gaming controller 42 may be arranged to shut off power to a peripheral 40 or otherwise “reboot” the peripheral in the event of a security breach. For example, a party may open an access door to an interior of the gaming device 20. If such a breach is detected (such as with a door sensor), the security event may be identified to the master gaming controller 42. The master gaming controller 42 may, in turn, shut power off to the peripheral 40. This erases the code from the peripheral's memory 56, rendering the peripheral useless for operation of the gaming device 20 and thwarting an attempt by the intruder/unauthorized person. Once the device 20 is again identified as secure, the master gaming controller 42 may again permit power to be provided to the peripheral 40. At that time, the peripheral 40 is arranged to download the code again or take other appropriate action.

In some implementations of the invention there is provided a method for verifying the peripheral code once downloaded to the peripheral 40. As stated above, it is desired that an authentic version of the peripheral code be accessible, whether provided from a central or remote server or stored directly at the master gaming controller 42. Such an authentication method is described below. Although the peripheral device performs many steps of the method according to the following example, in some preferred implementations the master gaming controller and/or another device performs such steps. In one such implementation, a server (or other device in computer room 420) authenticates the peripheral code, then transmits the peripheral code to a gaming machine. The gaming machine attempts to authenticate the peripheral code again and provides the peripheral code to the peripheral device only if the peripheral code can be authenticated. Accordingly, methods are provided for verifying the integrity of the code that is provided to the peripheral.

In one embodiment, once peripheral control code has been downloaded to the peripheral 40, the code is provided to the peripheral a second time. The peripheral 40 utilizes this second copy of the code in a verification procedure, comparing the stored first copy to the newly transmitted second copy. If differences are found between the two versions of the code, then the version of the code that was downloaded and stored is not deemed authentic. The controller 54 of the peripheral 40 may then be arranged to request a new, third copy of the code for download and storage in replacement of the code which is currently stored, and verification procedure may repeat In this embodiment, the second copy of the code is not stored permanently at the peripheral 40, but is only used in a comparison procedure. As is well known, this comparison procedure may comprise a bit-for-bit comparison or other method of verification now known or later developed. Of course, in this embodiment, the controller 54 of the peripheral 40 is provided with code arranged to cause the peripheral 40 to re-request the code after it has been stored, and to utilize this second requested copy of the code in the verification process.

In the above-referenced embodiment of verification, the peripheral 40 is adapted to perform the verification function. Of course, in that arrangement, the peripheral 40 must have sufficient computing power to perform the operation, and must be provided with either the software or hardware to perform the verification.

In another embodiment, the peripheral 40 is provided with code that is capable of calculating a signature associated with the code. This signature may be transferred back to the master gaming controller 42 for comparison against a signature similarly generated against the copy of the code stored there. If the signatures match, the code is deemed verified. If not, the code is not deemed verified.

In another embodiment, once the code is downloaded to the peripheral 40 and stored at the peripheral 40, the peripheral 40 sends the code back to the master gaming controller 42 other device. In the embodiment where an authentic copy of the code is stored at the master gaming controller 42, the code is sent back to the master gaming controller 42 and the master gaming controller 42 performs a verification function, comparing the authentic code to that forwarded by the peripheral. This arrangement has the benefit that the verification function can likely be performed more quickly and without interruption of other functions, as the master gaming controller 42 is likely to be provided with much greater processing power and data storage.

In either embodiment, the verification function is useful in detecting the corruption of the peripheral code. For example, a party may attempt to intercept code being downloaded to a bill validator peripheral. The intercepted code may be modified or replaced with other code, such as code that permits the user to pass counterfeit bills through the validator. The code may also be corrupted during the transfer, such as by electrical interference.

In one or more embodiments, the code verification may occur at various time intervals after downloading of the code. This assures that the code is not later tampered with at the peripheral 40.

In one or more embodiments, the data that is transferred in order to enable the peripheral and perform the verification or other functions may be encrypted. For example, the code that is downloaded to the peripheral 40 may be encrypted to further ensure its integrity. A variety of encryption methods and means for implementing these methods are known to those of skill in the art.

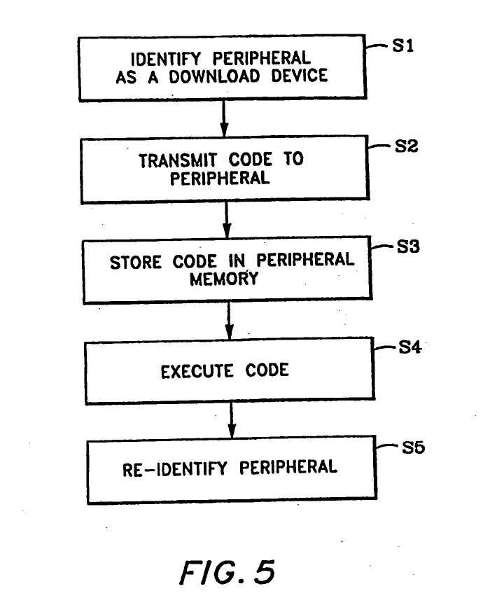

A method in accordance with the invention will be described with reference to FIG. 5. In one embodiment, in a first step S1, the peripheral identifies itself as a download device. In the embodiment where the peripheral 40 is associated with a USB device, when the peripheral 40 is connected to the USB, a voltage change occurs on one of two connecting wires. This causes the USB controller to query the peripheral 40 to determine its nature. In accordance with this embodiment of the invention, the USB engine or processor 54 of the peripheral 40 is arranged to identify itself as a “download” device requiring code for its operation. As stated above, in another embodiment the peripheral 40 identifies itself as a download device by executing resident code that instructs the master gaming controller 42 to download control code to it. In one or more embodiments, this first step S1 comprises the step of the peripheral 40 transmitting a signal to a remote location, such as the master gaming control 42, causing control code to be transmitted to the peripheral.

In a step S2, control code (such as in the form of an image file) is downloaded to the peripheral 40. In one embodiment, the code is provided directly from the master gaming controller 42. In another embodiment, the code is forwarded from a remote location to the master gaming controller 42, and then from the master gaming controller to the peripheral 40.

In a step S3, the control code is stored in the memory 56 of the peripheral. As stated above, the code may be stored directly in the memory 56 or first pass through the peripheral controller 54.

In a step S4, after the code has been received and stored by the peripheral 40, the code is executed, such as by the peripheral controller 54.

In a step S5, the peripheral 40 begins its normal operation in accordance with the executed downloaded code. In the embodiment where the peripheral 40 is a USB type device, this includes the step of the peripheral 40 disconnecting from the USB and then reconnecting. After the reconnection, the USB controller of the USB associated with the master controller 42 polls the peripheral 40. Now using the downloaded control code, the peripheral 40 identifies itself as the particular intended device, such as a bill validator, coin acceptor or the like. In another embodiment, once the control code is downloaded and stored, a jump code causes the peripheral to begin executing the control code, enabling operation of the peripheral device.

In one or more embodiments, the method includes the step of conducting code verification. In the embodiment of the invention described above where some fixed code is resident at the peripheral 40 instructing the download, this step may occur after the code has been downloaded and stored at the peripheral 40, but before the code is executed thereby (i.e., between steps S3 and S4 of the method illustrated in FIG. 5). In the embodiment where the peripheral 40 includes a USB engine or processor 54, verification is part of the downloaded code and occurs in conjunction with the code execution (i.e., at step S4). As stated above, the step of verification may comprise the step of resending the code for bitwise comparison by the peripheral 40, comprise the peripheral sending a copy of the code back to the master gaming controller 42 or other location for comparison, or comprise comparison of generated signatures.

In one or more embodiments, the method of the invention is applied to operational code and/or data. In such event, the informational data is supplied to the peripheral and used (i.e. executed) by the peripheral for controlling a display, sound generating device or the like.

As stated above, in a preferred embodiment of the invention, the code that is provided to the peripheral 40 is authentic. One embodiment of the invention thus includes a method of authenticating the code that is to be provided to the peripheral, such as authenticating the code that is stored at the gaming device 20. Preferably, the authentication of the code occurs before step 2 of the method described above and illustrated in FIG. 5, such that the authenticity of the code is ensured before it is provided to the peripheral. As described above, once the code is provided to the peripheral, the code may be further verified to ensure its integrity after its transfer to the peripheral.

In one embodiment, the code or other media to be authenticated contains authentication data, in one embodiment in the form of an authentication file. The authentication data comprises data generated at a secure location from trusted software, i.e., software that is known to be accurate and in some instances software that is approved by a regulatory body. In one embodiment the authentication data stored in the authentication file is in the form of a file verification table (FVT) configured to store a hash value entry for each file. To create the hash value entries stored in the FVT, hash operation algorithms stored on a secure memory are executed on each file stored on the media (fixed, removable, or any other) and the resulting hash value is stored in the FVT such that it in some way corresponds with the software file from which it was created. The FVT thus contains a unique value created by the hash operation for each file on the removable media.

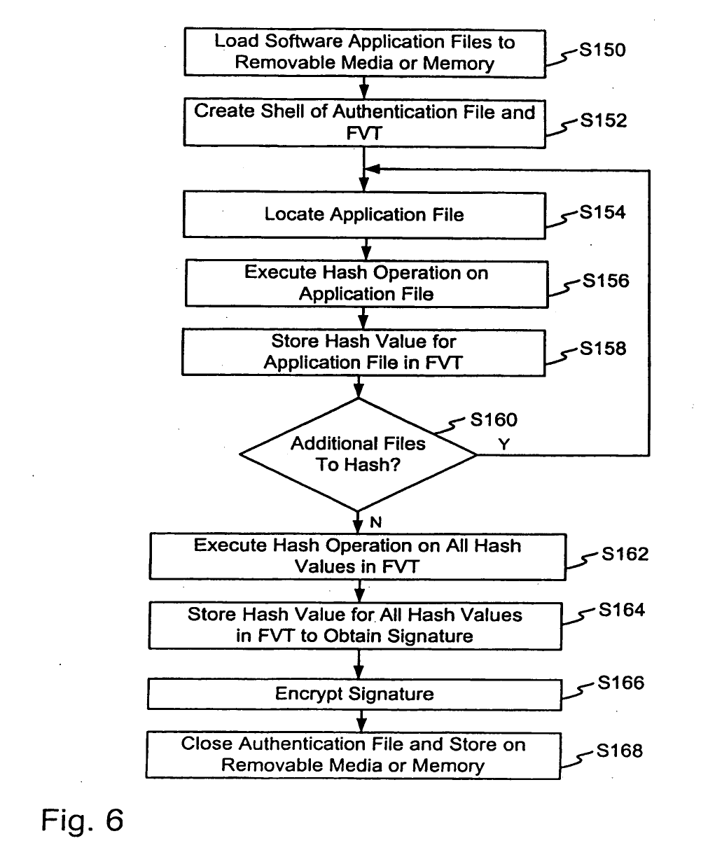

FIG. 6 illustrates an operation flow diagram of an example method of creating the authentication file. This method is one exemplary method of operation and it is contemplated that other methods of creating authentication data may be utilized. Further, this method is available for use on any of a removable media, fixed or mass media, software stored on a network, or other any other data storage apparatus. For example, the method is available for authenticating peripheral code that is stored on a removable CD-ROM associated with the master gaming controller 42. The method is also available for authenticating peripheral code that is stored at the mass storage device 46 of the master gaming controller 42.

At a step S150 the authentication data creation process loads software application files, such as the peripheral control code or video/audio peripheral operational data to a removable media. In other methods, the software may comprise files other than application files and the files may be loaded on the media prior to the initiation of the this process. Next, at a step S152, the operation creates a shell file that will become the authentication file storing the FVT.

At a step S154, the operation locates an application file. The process of locating the one or more files may occur in any manner known in the art. One such method comprises selecting an application file based on directory structures, while another method comprises selecting application files alpha-numerically. Once the first application file is selected, the operation executes a hash operation on the selected application file. The hash operation may comprise any hash operation capable of returning a unique value for a particular file. To facilitate a check at a later state of the authentication process, the hash operation used in obtaining the hash values for the FVT is preferably generally similar to the hash operation used in later stages of authentication. Using the same algorithm insures that a given file will yield an identical hash value if the file has not been altered.

Thereafter, at a step S158, the operation stores the hash value in the FVT. In one preferred embodiment the hash value is stored with an association with the application file from which the hash value was created. Next, at a decision step S1160, the operation determines if there are additional files on the media to execute the hash operation. If there are files for which a hash value has not been created, then the operation returns to step S154 and the operation repeats. If at decision step S160 the operation determines that no additional files exist on which to perform the hash operation, then the operation progresses to a step S162 and the method executes the hash operation on all hash values presently stored in the FVT. The hash operation creates a unique hash value for the hash values stored in the FVT to provide means to detect tampering or unwanted alteration of the hash values in the FVT. This hash value generated by executing the hash operation on the stored hash values is referred to herein as a content signature of the hash values. Next, at a step S163, the operation encrypts the content signature and stores it in the FVT. Next, at a step S164, the operation hashes the entire FVT file and obtains a signature for the entire FVT file.

Next, at a step S166 the operation encrypts the signature value and stores it in the FVT. In one embodiment this value, the encrypted signature value for the FVT is appended to the end of the file. Encryption of the signature prevents the alteration of the signature, thereby providing additional security against tampering. At a step S168 the operation closes the authentication files and stores the authentication file on the removable media or other location, such as the mass storage 46 of the master gaming controller 42. The FVT within the authentication file is thus available if the removable media or other memory/file is used in the future. The FVT contains unique data created based on the content of the removable media when the content of the removable media was known to be trusted as accurate.

In other configurations, the FVT is created or stored on media other than the removable media, such as a fixed media like a hard drive, to provide authentication capability.

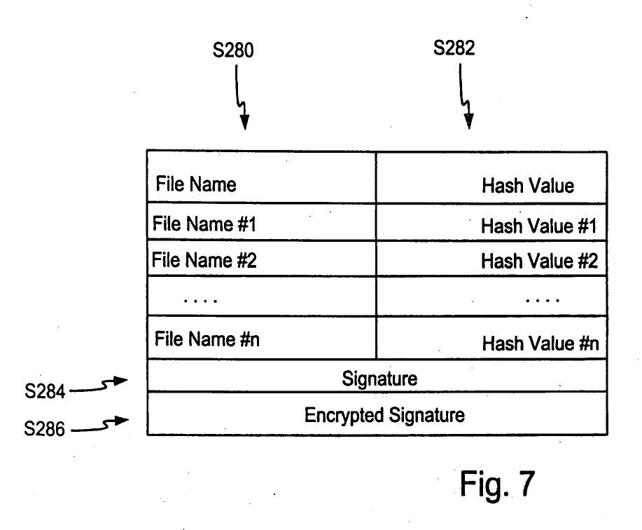

FIG. 7 illustrates an example configuration of a file verification table (FVT) as contained within the authentication file. In this example configuration, the FVT contains a listing of each file 280, identified by name. Associated with each file is the hash value 282. The hash value is the unique value created by executing the hash operation on each file 280 associated with the removable media. The FVT also contains an encrypted content signature 284 which is an encrypted hash value obtained from executing the hash operation on each of the hash values 282. The FVT also contains an encrypted file signature 286. This is but one possible arrangement and exemplary content of data to assist in the authentication of software or data contained on a media for use in a device. Those of ordinary skill in the art will understand that other arrangements are possible without departing from the scope of the invention. The FVT may be stored on the media with which it is associated or at a different location.

Once the above described authentication file is on a media (fixed, removable, or other) it provides a unique key to determine if the software on the media (such as the peripheral control code file or data file containing audio/video or other peripheral operational data) has been altered since the authentication file was created. The media or files/data can then be put to any use intended and using the authentication file a determination can be made whether the software on the media has been altered. The authentication process is described below.

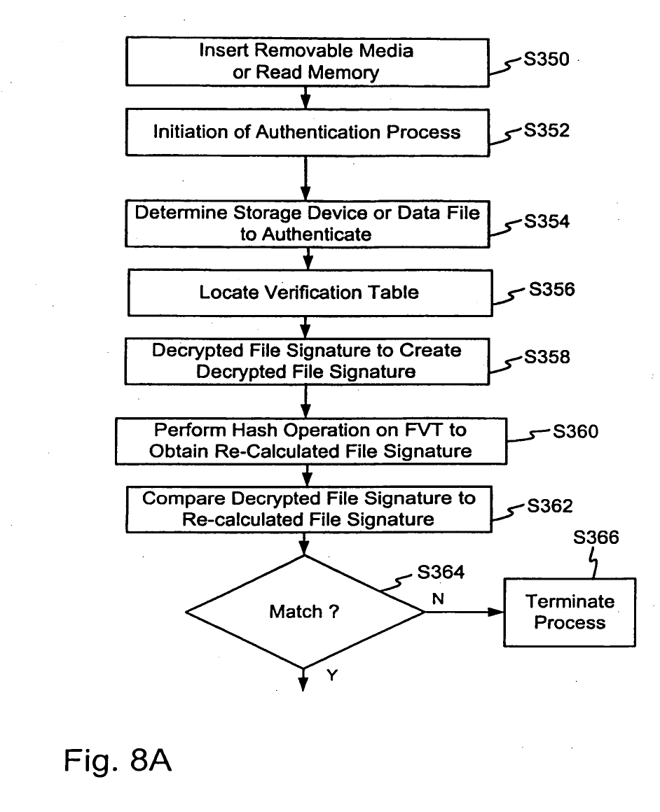

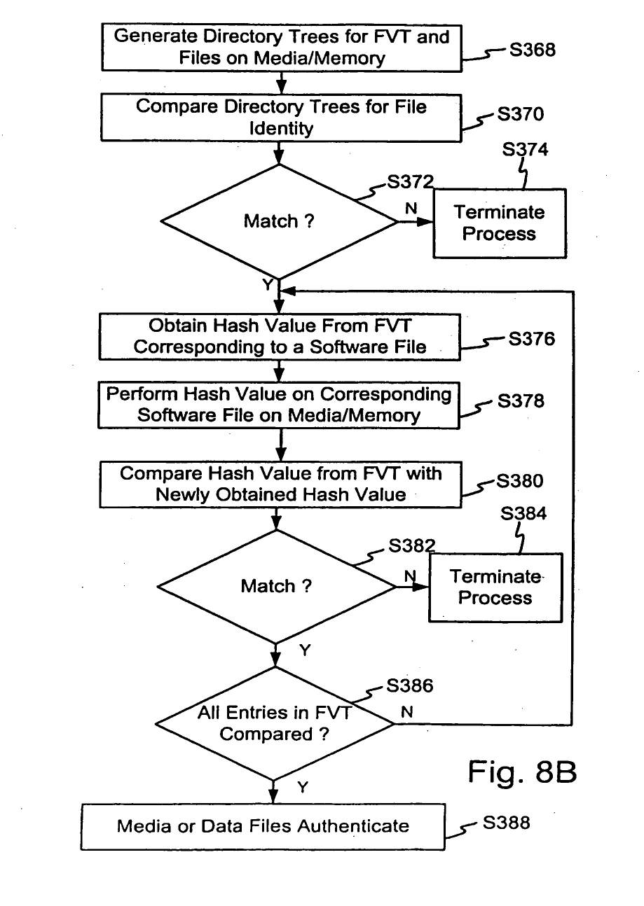

FIGS. 8A and 8B illustrate an operation flow diagram of an exemplary method of authentication. In one environment, this method is performed, for example, to establish that the software control code (such as in the form of one or more image files) on the gaming controller 42 is authentic. The method described below is in reference to authentication of a removable media, such as a CD-ROM containing the peripheral code. In reference to FIG. 8A, at a step S350 a user inserts a removable media into a removable reader (such as a CD-ROM drive). Thereafter, at a step S352 the process of authentication can automatically occur or require some event from a user. At a step S354 the operation determines a media to authenticate. Any order of authentication is acceptable. As described, in a preferred embodiment of the invention, the authentication may occur on one or more files used to control a peripheral device that may be stored anywhere.

Next, at a step S356, the operation searches the media for the verification file stored on the media. The creation and content of the verification file is discussed above. At a step S358, the operation utilizes the decryption algorithms from the secure memory to decrypt the file signature stored in the FVT. The encrypted file signature is shown as element S286 on FIG. 7. After decrypting the file signature value stored in the FVT, the operation performs a hash operation on the FVT file up to the encrypted content signature S284, to obtain a re-calculated file signature. This occurs at a step S360. Thereafter, at a step S362, the operation compares the decrypted signature to the re-calculate file signature to check for differences in the values. At a decision step S364, a determination is made whether the signatures match. If the decrypted signature does not match the re-calculated signature, the operation progresses to a step S366 and the process terminates. Such a failure to match at step S364 indicates possible tampering or alteration and the installation or game operation should not occur or may have occurred inaccurately.

If at decision step S364 the operation determines the decrypted signature matches the recalculated signature, the operation progresses to a step S368 wherein the operation generates a directory tree or other directory and/or file listing of the files on the media and the FVT. Any various structure or listing of directories and/or files can be utilized such that it facilitates a comparison between the directory trees or structure and/or the files on the FVT and the media. This comparison, that occurs at a step S370 indicates whether the same directories and/or files exists on the media as compared to the listing in the FVT as was recorded at a prior time when the media content was known to be trusted. At a decision step S372 the method determines if there is a match between the directories or files recorded in the FVT and the directories or files currently on the media. If there is not a match, the operation moves to a step S374 and the process terminates.

If there is a match at step S372, the operation progresses to a step S380. At step S380, the operation begins performing the hash operation on each file stored on the media and comparing the resulting hash value to the hash value stored in the FVT. Thus, at step S380 the operation obtains a hash value corresponding to a file. The hash value is obtained from the FVT. Next at a step S382, the operation locates the corresponding file on the media and performs the hash operation on the file. It is preferred that an identical hash function be utilized at step S382 as was used to create the entries in the FVT.

At a step S384, the operation compares the hash value from the FVT to the re-calculated hash value for the corresponding software file stored on the media. At a decision step S386 a determination is made as to whether these two hash values match. If the values do not match, the operation moves to a step S388 and the process terminates. If the values match, the operation moves to a decision step S390 wherein the operation determines if all the entries of the FVT have been compared to re-calculated values.

If at decision step S390 there are additional FVT entries to compare, the operation returns to step S380 and the operation repeats as shown. If at decision step S390 all the FVT entries have been compared to re-calculated entries, the operation progress to a step S392 wherein the determination is made that the media (such as peripheral control code files) has been authenticated. It is contemplated that this process can occur on any media (including control code files, operational data such as audio/video data) for which authentication is desired. It is further contemplated that many other variations may be made to the general process outlined herein without departing in scope of authentication to determine that the software control code on the media, fixed, removable, or otherwise, is trustworthy.

One or more embodiments of the invention comprise a method of updating the control code of a peripheral 40 while the peripheral 40 is operating using already provided code. For example, a bill validator may be provided with particular code enabling its operation as part of a gaming device. During the continued operation of the gaming device, it may be determined that the code of the bill validator must be changed, such as to accommodate a change in currency format or by operator request. In accordance with an embodiment of the invention, this process may occur without powering down the gaming device. In particular, the new control code may be provided to the master gaming controller 42 through a download process. The master gaming controller 42 may then send a signal to the peripheral 40 instructing it to accept the new code in a download process, overwriting the old code. In one embodiment, the master gaming controller 42 may be caused to disconnect the peripheral 40, effectuating a “reboot” in which the peripheral 40 now identifies itself as a download device again, starting the process at step S1 of the above-described method. The reboot process may automatically include the above-described authentication process.

One or more embodiments of the invention comprise the operation of a gaming device including a peripheral 40. In one embodiment, the method includes the step of initiating operation of the gaming device 20. This step preferably includes the step of providing the control code that the peripheral 40 will use to operate, in accordance with the above-referenced method. The initiation step may include shutting off power to the peripheral 40, and/or master gaming controller 42 or entire gaming device 20, and then providing power again. As disclosed above, in some preferred embodiments, shutting off the power to the peripheral 40 causes the previously stored control code to be erased. When power is again provided to the peripheral 40, the peripheral 40 is preferably supplied with peripheral code automatically. The gaming machine (e.g., master gaming controller 42 or the peripheral device itself), bank switch, or another device transmits a signal, such as the above-referenced data identifying the peripheral as a download device, such that the control code is transmitted to the peripheral for storage and then execution. In one or more other embodiments, the initiation of operation may comprise only rebooting the peripheral 40 (such as by triggering the reset/enumeration function of the peripheral) causing the master gaming controller to recognize the peripheral as a download device and provide the control code that will be used to control its operation. This rebooting may be accomplished in a variety of manners. For example, a signal may be sent from the master gaming controller 42 causing the peripheral 40 to initiate a reset or reboot function.

In one or more embodiments, the peripheral 40 may be caused to erase its stored control code in the event a reboot function is executed. In such event, the resident control code is erased, and the peripheral seeks new control code for storage and execution. In another embodiment, the resident control code may simply be overwritten.

Many advantages are realized by the invention. In accordance with the invention, code for operation/execution by a peripheral device may be conveniently updated without needing to access the peripheral device mechanically.

A method of providing code to a peripheral is provided which ensures the integrity of the code. The method ensures that the code that is downloaded to the peripheral is not corrupt or tampered with.

In accordance with the invention, a method and apparatus is defined which ensures the integrity of the code download procedure without risk of peripheral inoperability. As described above, one problem associated with updating the control code of a device is that an interruption may occur during the code write procedure. In such event, the device may be rendered inoperable. The resident peripheral control code may be sufficiently overwritten before the interruption that the resident code is not sufficient to operate the device after the interruption to permit the download to continue or restart. In addition, the new code may be insufficiently written to permit its execution for controlling the device, again preventing the device from completing the code install.

As will be appreciated, interruptions during such a code installation may arise from a wide variety of sources and are not uncommon. In the realm of gaming device, such interruptions may occur due to network instability electric shock and interference and other factors.

In accordance with the invention, such an interruption will not render the peripheral inoperable. In the preferred embodiment of the invention, the peripheral includes fixed code that cannot be overwritten and always enables basic operation of the peripheral. In a preferred embodiment, the fixed code is only that code sufficient to enable the peripheral 40 to communicate with the master gaming controller 42 to obtain control code via the download process. In another embodiment, as described in detail above, the peripheral 40 identifies itself as a download device and accepts code from the master gaming controller 42 which enables further operation of the peripheral 40.

Another advantage of the invention is that all of the code for controlling all of the peripherals of a gaming machine can be authenticated and delivered to the peripherals for enabling operation of the machine at the same time. For example, a gaming machine may be manufactured and then delivered with firmware or have the firmware uploaded or installed once delivered. This entire block of firmware may be authenticated at once. Then, the code for all of the peripherals of the device may be installed from the firmware, enabling operation of the machine.

The method of the invention is useful in ensuring that the code associated with the operation of peripherals of many computers are all updated. In one embodiment, the gaming controller may be provided with code that it provides to the peripheral. In accordance with the verification method(s) as described above, it may be determined if the provided code matches that which the peripheral is currently utilizing. If not, then the gaming controller/peripheral may be caused to automatically update the operating code by accepting the new code. This method ensures that one or more peripherals of a gaming machine are not operating with old code.

Some methods and devices of the invention are useful in authenticating many types of code or data, such as may be used by a video display or sound generating peripheral of a gaming machine. Further, such methods and devices may be useful in updating this code and/or data to the peripheral. In this manner, a wide variety of information associated with the operation or control of a peripheral of the gaming machine may be authenticated, verified, and updated.

Some additional features of the invention will now be described with reference to FIG. 9. Method 900 begins when first peripheral code is received (step 901) and authenticated (step 905). As mentioned elsewhere herein, various devices may be involved in the receipt and authentication of peripheral code. For example, a server in casino computer room 420 may receive the peripheral code from central system 463. If the server could not authenticate the code, the server may request a replacement copy of the code. After authentication, the server may store a copy of the peripheral code in a database and associated with a particular peripheral type.

Subsequently, the peripheral code may be provided to a gaming machine, e.g., to gaming machine 20a. This step may be taken, e.g., when (or soon after) gaming machine 20a initializes, upon request or when predetermined conditions are achieved. A logic device of the gaming machine (which may or may not be a master gaming controller) may then attempt to authenticate the peripheral code. In some implementations, an Arbiter may be involved in an authentication and/or encryption/decryption process, as described above with reference to FIG. 4C.

If the code can be authenticated, it may then be provided to the peripheral device and loaded into memory. (Step 910.) The peripheral device will be controlled according to the peripheral code that has been loaded into memory.

In step 920, it is determined whether a triggering event has occurred. This determination may be made by one or more of various devices, depending in part on the nature of the event.

Some triggers may involve error detection and/or a failed authentication. For example, a cyclical redundancy check (“CRC”) of communications from a peripheral device may periodically be performed in order to confirm that there is no unintentional corruption. A CRC failure could trigger a download of new peripheral code. Alternatively, or additionally, a trigger could involve the failure of a peripheral device to provide an acceptable response to an authentication challenge from another device, such as a master gaming controller of the associated gaming machine.

The trigger could involve error detection. For example, if a bill validator fails to accept bills more than a threshold percent of the time (e.g., >10%), this could indicate a problem with hardware and/or software; therefore, a software download could be triggered. Similarly, if it is determined that a device has performed more than a predetermined number of sequential operations, that could be a trigger. In some implementations, the passage of time and/or the attainment of a use threshold (e.g., 10,000 bills received by a bill validator) may be a triggering event.

The occurrence of large wins could be a triggering event. Because these are significant events, one wants to ensure that the gaming machine is secure and valid. The Nevada Gaming Commission requires this sort of check when, e.g., there is a Mega Jackpot™ hit.

If a bill validator is rejecting a lot of bills or tickets, the underlying reason could be that someone is trying to use counterfeit money or tickets. Therefore, in addition to downloading new software, countermeasures may be triggered in response to a positive indication in step 920. The countermeasures may include an evaluation of error codes, etc., and/or human intervention. For example, if the same gaming machine (or nearby gaming machines) are rejecting tickets and/or currency for the same reason (e.g., the ticket has already been used), a person may be sent to investigate.

The disconnection of a cable, such as an Ethernet cable, could be a critical event. As mentioned elsewhere, various aspects of the invention may be implemented via USB, Ethernet, FireWire, etc. Many communication protocols may be used to implement the invention, although those that allow relatively high communication speed are generally preferable. As mentioned above, some implementations consider the initializing of a gaming machine and/or a peripheral device to be a triggering event.

As mentioned above, one such triggering event involves a change in gaming machine location. Various devices, including a bank switch, a location detection device (such as an RFID reader), a dedicated server and/or a gaming device itself may detect a change in location. Gaming devices, particularly mobile gaming devices, may be equipped with GPS capability, may be configured to emit a tracking signal, etc.

It may be desirable to change at least some aspect of software used by a gaming machine or mobile gaming device in accordance with a change in location. A different type of software may be desirable for a bill acceptor or the like in a high roller area, as compared with other parts of a casino floor. Some areas of a gaming establishment may have restrictions as to the game class that can be played. For example, Class III game play may be restricted to a particular area of a casino. In other areas of a gaming establishment, wagering may not be permitted at all. A gaming device should preferably be re-provisioned with appropriate software when such a location change has been detected. Similarly, if a gaming machine or mobile gaming device is moved to another jurisdiction, this could trigger the downloading of software pertaining to that jurisdiction.

A triggering event may involve a change in the regulatory requirements of one or more jurisdictions. For example, a database accessible by a gaming network may indicate current state and federal regulatory requirements of various jurisdictions. Some such regulatory requirements may relate to peripheral capabilities. Accordingly, an update of such a database may comprise an event that can be evaluated to determine whether the event is a triggering event.

If no triggering event is detected, the peripheral continues to operate according to the stored peripheral code. However, if a triggering event is detected, new peripheral code is provided to the peripheral device. In this example, the new peripheral code is downloaded to gaming machine by a server in the gaming establishment or in an affiliated gaming establishment. (Step 925.) If the new peripheral code can be authenticated (step 930), it is loaded into a memory of the peripheral device (step 935) and the peripheral device is controlled according to the new peripheral code. (Step 940.)

It will be understood that the above-described arrangements of devices and the above-described methods are merely illustrative of applications of the principles of this invention and that many other embodiments and modifications may be made without departing from the spirit and scope of the invention.

We claim:

1. A peripheral device for a gaming machine, comprising:
an interface configured for communication with a gaming machine;
a volatile memory; and
a logic device configured to determine when first peripheral code is received from the gaming machine, to load the first peripheral code in the volatile memory and to control functionality of the peripheral device according to the first peripheral code.

2. The peripheral device of claim 1, wherein the peripheral device is configured to receive new peripheral code each time the peripheral device initializes.

3. The peripheral device of claim 1, wherein the first peripheral code is purged from the volatile memory when the peripheral device powers down.

4. The peripheral device of claim 1, wherein the logic device is configured to detect a potential triggering event and to send corresponding event data to the gaming machine.

5. The peripheral device of claim 1, wherein the logic device is further configured to perform the following steps:
determine when second peripheral code is received from the gaming machine; and, when the logic device determines that the peripheral device has received second peripheral code from the gaming machine,
purge the first peripheral code from the volatile memory;
load the second peripheral code in the volatile memory; and
control functionality of the peripheral device according to the second peripheral code.

6. The peripheral device of claim 1, wherein the interface comprises a Universal Serial Bus (“USB”) interface.

7. The peripheral device of claim 1, wherein the logic device comprises a microcontroller selected from the EZ-USB microcontroller family.

8. The peripheral device of claim 1, further comprising a non-volatile memory of sufficient size for storing a boot program.

9. The peripheral device of claim 3, wherein the logic device is configured to perform the following steps when the peripheral device re-initializes:
determine when second peripheral code is received from the gaming machine;
load the second peripheral code in the volatile memory; and
control functionality of the peripheral device according to the second peripheral code.

10. The peripheral device of claim 8, wherein at least one logic device is further configured to store state information in the non-volatile memory.

11. A gaming machine, comprising:
means for providing wagering games, the providing means comprising a plurality of peripheral devices;
a network interface; and
at least one logic device configured to perform the following tasks:
determine when first peripheral code received via the network interface;
provide the first peripheral code to a first peripheral device; and
detect a possible triggering event that may require new peripheral code for the first peripheral device.

12. The gaming machine of claim 11, wherein at least one logic device is further configured to determine whether the possible triggering event requires new peripheral code for the first peripheral device.

13. The gaming machine of claim 11, wherein at least one logic device is further configured to cause event data regarding the possible triggering event to be sent to a second device that is configured to determine whether the possible triggering event requires new peripheral code for the first peripheral device.

14. The gaming machine of claim 11, wherein at least one logic device comprises a Universal Serial Bus (“USB”) configured for communication with the first peripheral device.

15. The gaming machine of claim 12, wherein at least one logic device is further configured to request a download of second peripheral code when it is determined that the event comprises a triggering event.

16. The gaming machine of claim 13, wherein the second device comprises a server, a kiosk, a host device or another gaming machine.

17. The gaming machine of claim 13, wherein at least one logic device is further configured to request a download of second peripheral code when it is determined that the event comprises a triggering event.

18. The gaming machine of claim 14, wherein the USB comprises a USB controller and at least one port configured for communication with the first peripheral device.

19. A method, comprising:
receiving first peripheral code;
loading the first peripheral code in a memory of a peripheral device of a gaming machine;
controlling the peripheral device according to the first peripheral code to provide a feature relating to wagering games presented on the gaming machine;
detecting an event; and
determining whether to download second peripheral code based, at least in part, on whether the event comprises a triggering event.

20. The method of claim 19, wherein the detecting step is performed by the gaming machine.

21. The method of claim 19, wherein the detecting step is performed by the peripheral device.

22. The method of claim 19, wherein the memory is a volatile memory.

23. The method of claim 19, further comprising deleting the first peripheral code when the peripheral device powers down.

24. The method of claim 19, wherein the receiving step is performed by the gaming machine, further comprising the step of authenticating the first peripheral code by the gaming machine prior to loading the first peripheral code in the memory of the peripheral device.

25. The method of claim 19, wherein it is determined that the potential triggering event is an actual triggering event, further comprising:
receiving the second peripheral code;
loading the second peripheral code in the memory; and
controlling the peripheral device according to the second peripheral code.

26. The method of claim 19, wherein the event comprises a power fluctuation and wherein the determining step comprises determining whether the power fluctuation exceeds predetermined parameters.

27. The method of claim 19, wherein the event comprises an elapsing of a period of time and wherein the determining step comprises determining whether the period of time comprises, at least in part, a triggering event.

28. The method of claim 19, wherein the event comprises an indication of an attempted access to the interior of the gaming machine.

29. The method of claim 19, wherein the event comprises a CRC failure.

30. The method of claim 19, wherein the event comprises an audit request.

31. The method of claim 19, wherein the event comprises a relocation of the gaming machine, a reconfiguration of the gaming machine or a release of new peripheral code.

32. The method of claim 19, wherein the event comprises a change in the regulatory requirements of one or more jurisdictions.

33. The method of claim 19, wherein the determining step comprises determining that a predetermined number of errors has been exceeded.

34. The method of claim 19, wherein the determining step comprises determining that a predetermined number of operations has been exceeded.

35. The method of claim 19, wherein the determining step comprises determining that a predetermined transaction has been requested.

36. The method of claim 19, wherein the determining step comprises determining that a predetermined number of errors has been exceeded.

37. The method of claim 19, wherein the peripheral device is provided with new peripheral code after each time the gaming machine initializes.

38. The method of claim 19, further comprising the step of deleting the first peripheral code from the memory when the gaming machine powers down.

39. The method of claim 20, further comprising transmitting event data from the gaming machine to a second device, wherein the second device performs the determining step.

40. The method of claim 21, further comprising transmitting event data from the peripheral device to the gaming machine, wherein the gaming machine performs the determining step.

41. The method of claim 34, wherein the operations comprise financial transactions involving at least a predetermined monetary amount.

42. The method of claim 39, wherein the second device comprises a server, a kiosk, a host device or another gaming machine.

43. The method of claim 40, further comprising transmitting event data from the gaming machine to a second device, wherein the second device performs the determining step.

44. Software stored in one or more machine-readable media, the software including instructions for controlling elements of a gaming network to perform the following steps:
receive first peripheral code;
load the first peripheral code in a memory of a peripheral device of a gaming machine;
control the peripheral device according to the first peripheral code to provide a feature relating to wagering games presented on the gaming machine;
detect an event;
determine whether the event comprises a triggering event; and
ascertain whether to download second peripheral code based, at least in part, on whether the event comprises a triggering event.

45. The software of claim 44, wherein the software controls the gaming machine to perform the determining step.

46. The method of claim 44, wherein the software controls a server to perform the determining step.

47. The method of claim 45, wherein the software controls the peripheral device to perform the detecting step, further comprising the step of forwarding event data to the gaming machine.

48. The method of claim 46, wherein the software controls the peripheral device or the gaming machine to perform the detecting step, further comprising the step of forwarding event data to the server.

49. The method of claim 46, wherein the software controls the server to perform the detecting step.

50. The method of claim 49, wherein the event comprises a regulatory requirement.

51. A method of operating a gaming device including a game device controller and at least one peripheral having a peripheral controller associated with said game device controller comprising the steps of:
initiating operation of said gaming device;
transmitting a signal from said peripheral device to said game device controller causing said game device controller to provide control code to said peripheral device;
authenticating said control code;
transmitting said control code to said peripheral device;
storing said control code at said programmable memory of said peripheral device; and executing said control code with said peripheral controller for effecting operation of said peripheral device.

52. A gaming device for presenting a game for play to a player, said gaming device comprising:
at least one game control device;
at least one peripheral device associated with said game control device;
a peripheral controller for controlling said peripheral device;
resident code adapted to cause said peripheral controller to obtain control code for controlling the operation of said peripheral device;
programmable data storage for storing control code transmitted to said peripheral device in response to a signal provided to said game control device.
